(19) United States
(12) Patent Application Publication
(10) Pub. No.: US 2017/0179488 A1
(43) Pub. Date: Jun. 22, 2017

(54) ELECTRODE HAVING ELECTRICALLY ACTIVATED MATRIX

(71) Applicant: NISSAN NORTH AMERICA, INC., Franklin, TN (US)

(72) Inventors: XIAOGUANG HAO, Burnsville, MN (US); KENZO OSHIHARA, Farmington Hills, MI (US)

(21) Appl. No.: 14/977,843

(22) Filed: Dec. 22, 2015

(51) Int. Cl. H01M 4/62; H01M 4/38; H01M 4/587; H01M 10/0525

(52) U.S. Cl. CPC H01M 4/62; H01M 10/0525; H01M 4/386; H01M 4/387; H01M 4/587; H01M 2220/20

(57) ABSTRACT

Electrodes incorporate an electrically activated matrix into which active material is provided. The active material includes alloying particles, which, as used herein, are active catalyst particles that have a high lithium storage capacity resulting in large volume expansions during lithiation. The electrically activated matrix is activated during charging and discharging of the battery, and when activated, maintains the electrode structure and stability by expanding and contracting with the volume expansion and contraction of the alloying particles during lithiation and delithiation, respectively. The electrically activated matrix also reduces cracking and pulverization of the alloying particles, maintaining electrical conductivity between active materials, thereby maintaining battery energy density through the life of the battery.

### TECHNICAL FIELD

This disclosure relates to an electrode for a lithium ion battery having an electrically activated matrix formed from a functionalized polymer material, and a process for electrical activation of the matrix.

### BACKGROUND

Hybrid vehicles (HEV) and electric vehicles (EV) use chargeable-dischargeable energy storages. Secondary batteries such as lithium-ion batteries are typical energy storages for HEV and EV vehicles. Lithium-ion secondary batteries typically use carbon, such as graphite, as the anode electrode. Graphite materials are very stable and exhibit good cycle-life and durability. However, graphite material suffers from a low theoretical lithium storage capacity of only about 372 mAh/g. This low storage capacity results in poor energy density of the lithium-ion battery and low electric mileage per charge.

To increase the theoretical lithium storage capacity, silicon has been added to active materials. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon causes particle cracking and pulverization. This deteriorative phenomenon escalates to the electrode level, leading to electrode delamination, loss of porosity, electrical isolation of the active material, increase in electrode thickness, rapid capacity fade and ultimate cell failure.

### SUMMARY

Disclosed herein are electrodes that incorporate an electrically activated matrix into which active material is provided. The active material includes alloying particles, which, as used herein, are active catalyst particles that have a high lithium storage capacity resulting in large volume expansions during lithiation. The electrically activated matrix is activated during charging and discharging of the battery, and when activated, maintains the electrode structure and stability by expanding and contracting with the volume expansion and contraction of the alloying particles during lithiation and delithiation, respectively. The electrically activated matrix also reduces cracking and pulverization of the alloying particles, maintaining electrical conductivity between active materials, thereby maintaining battery energy density through the life of the battery.

Also disclosed are lithium ion batteries having the electrodes taught herein. One example of a lithium ion battery has an anode comprising a current collector, a separator, and an electrically activated matrix formed from a polymer material having a functional group capable of changing chain length upon electrical activation. The electrically activated matrix is positioned between the current collector and the separator. An active material layer comprises active particles that undergo volume expansion of greater than 50% during discharge of the battery and is deposited in the electrically activated matrix. During discharge of the battery, the active particles are in an expanded state and the electrically activated matrix is in a contracted state due to electrical activation, such that a force on the active particles from the electrically activated matrix in the contracted state forces expansion of the active particles in one planar direction. During charging of the battery, the active particles are in an unexpanded state and the electrically activated matrix is in an uncontracted state.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a plan view of an active material layer for an electrode as disclosed herein;

FIG. 2 is a plan view of the active material layer of FIG. 1 in an expanded state;

FIG. 3 is a side view of the active material layer of FIG. 1;

FIG. 4 is a side view of the active material layer of FIG. 2;

FIG. 5A is a plan view of another active material layer of an electrode as disclosed herein;

FIG. 5B is a side view of the active material layer of FIG. 5A;

FIG. 6 is a side view of an embodiment of an electrode as disclosed herein;

FIG. 7 is a side view of another embodiment of an electrode as disclosed herein; and

FIG. 8 is a side view of yet another embodiment of an electrode as disclosed herein.

### DETAILED DESCRIPTION

Because the carbon material used in electrodes of conventional batteries, such as lithium ion batteries or sodium ion batteries, suffers from a low specific capacity, the conventional battery has poor energy density even though there is small polarization and good stability. Furthermore, batteries having electrodes of graphite or other carbon materials develop increased internal resistance over time, which decreases their ability to deliver current.

To address the poor energy density of carbon based electrodes, alternative active materials with higher energy densities are desired. Silicon, tin, germanium and their oxides and alloys are non-limiting examples of materials that may be added to an electrode active material layer to improve its energy density, among other benefits. One particular example is the use of silicon in lithium-ion batteries. Silicon based anode active materials have potential as a replacement for the carbon material of conventional lithium-ion battery anodes due to silicon's high theoretical lithium storage capacity of 3500 to 4400 mAh/g. Such a high theoretical storage capacity could significantly enhance the energy density of the lithium-ion batteries. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon can cause particle cracking and pulverization when the silicon has no room to expand. This expansion can lead to electrode delamination, electrical isolation of the active material, capacity fade due to collapsed conductive pathways, and, like carbon based electrodes, increased internal resistance over time, which decreases their ability to deliver current.

Disclosed herein are electrodes that incorporate an electrically activated matrix into which active material is provided. The active material includes alloying particles, which, as used herein, are active catalyst particles that have a high lithium storage capacity resulting in large volume expansions during lithiation. The electrically activated matrix is activated during charging and discharging of the battery, and when activated, maintains the electrode structure and stability by expanding and contracting with the volume expansion and contraction of the alloying particles during lithiation and delithiation, respectively. The electrically activated matrix also reduces cracking and pulverization of the alloying particles, maintaining electrical conductivity between active materials, thereby maintaining battery energy density through the life of the battery.

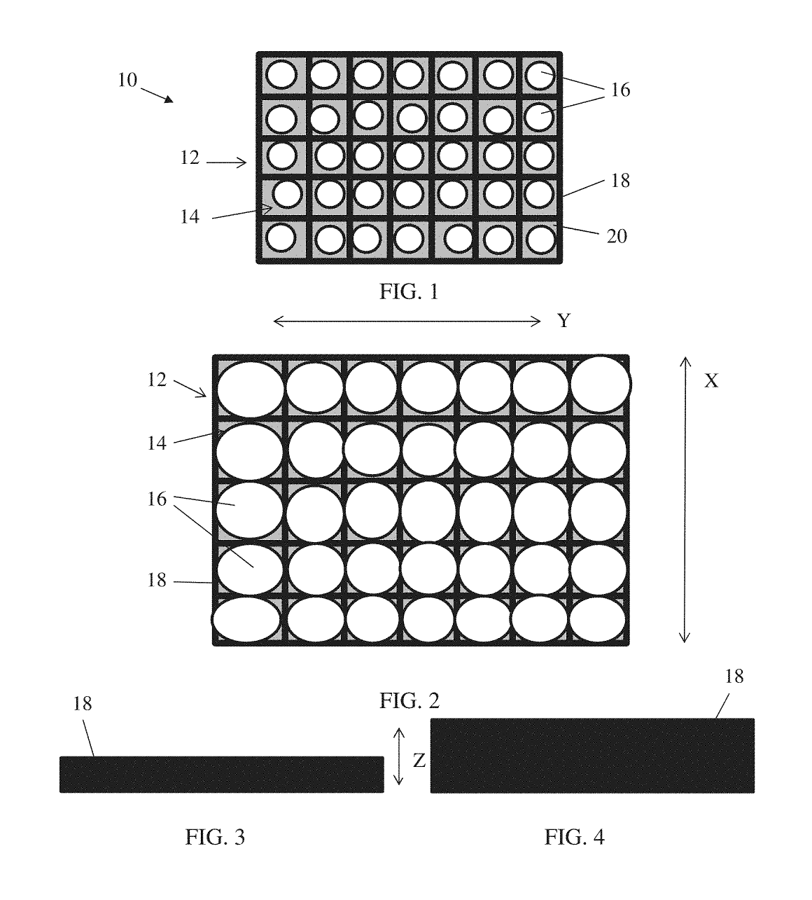

As schematically illustrated in FIG. 1, an electrode 10 for a lithium ion battery has an active material layer 12 including an active material 14 comprising alloying particles 16 having high specific capacities and an electrically activated matrix 18 formed from a functionalized polymer material. The active material 14 is deposited in the electrically activated matrix 18, which is configured to undergo reversible expansion and contraction during activation.

As illustrated in FIG. 2, during discharge, the alloying particles 16 are in an expanded state due to lithiation and the electrically activated matrix is in an expandable state due to electrical activation, such that as the alloying particles 16 expand against the electrically activated matrix 18, the electrically activated matrix 18 also expands. During charging, the alloyed particles 16 contract, or are in an unexpanded state and the electrically activated matrix 18 contracts with the alloying particles 16 to its unexpanded state.

The electrically activated matrix 18 is formed from a functionalized polymer, a material that exhibits stimuli-responsive functions, thus achieving a desired output upon being subjected to a specific input. Polymeric materials exhibit a range of mechanical responses which depend on the chemical and physical structure of the polymer chains. At the microscopic level, the mobility of polymer chains in the presence of an external stimulus is dependent on the degree of cross-linking and entanglements present in the polymer, as well as the functional groups used along the polymer chain. There are several ways in which structures having functional chemical groups or chains of homopolymers or copolymers grafted onto a polymeric backbone can be generated, and are known to those skilled in the art.

The functionalized polymer used to form the matrix will be selected based on the operating temperature of the electrode, the required activation voltage of the material, the operational voltage of the electrode, the change in chain length desired and the direction of change in change length desired, as non-limiting examples.

As the alloying particles 16 expand, the electrically activated matrix 18 also expands, but in a controlled manner as described herein. As illustrated in FIG. 2, the expansion occurs in the X-Y plane perpendicular to a stacking direction of the electrode 10. As illustrated in FIGS. 3 and 4, side views of the electrically activated matrix 18, the expansion occurs along the Z axis parallel to the stacking direction of the electrode 10. The expansion can be isometric, occurring along the X, Y and Z axes as well, with the electrically activated matrix 18 controlling the amount of expansion in all directions. Depending on how the electrode structure is formed, a uni-directional expansion may be desired. Accordingly, the functionalized polymer would be one that extends in length in the desired direction under the operating stimulus of the electrode, such as voltage or temperature, expanding in one direction while preventing expansion of the alloying particles 16 in other directions.

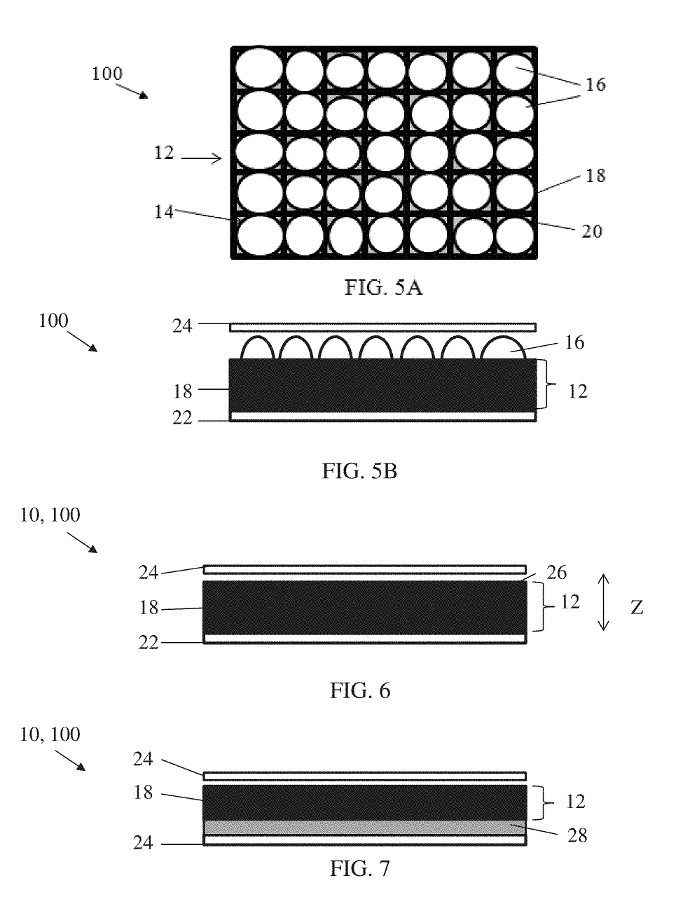

In another embodiment of an electrode 100, illustrated in FIGS. 5A and 5B, the functionalized polymer is selected to contract in at least one direction when electrically activated. During discharge, the alloying particles 16 are in an expanding state due to lithiation and the electrically activated matrix 18 is in a contracting state due to electrical activation, such that as the alloying particles 16 attempt to expand against the electrically activated matrix 18, the electrically activated matrix 18 exerts an opposite force on the alloying particles 16, forcing the alloying particles 16 to expand away from the electrically activated matrix 18. During charging, the alloying particles 16 contract to an unexpanded state due to delithiation.

The electrode 100 of FIG. 5B has a current collector 22 adjacent the active material layer 12 and a separator 24 adjacent the active material layer 12, opposite the current collector 22. The electrically activated matrix 18 is formed of walls (seen in FIG. 5A) perpendicular to the current collector 22, the walls contracting against the alloying particles 16 in the expanding state, forcing expansion of the alloying particles 16 toward the separator 24, as illustrated in FIG. 5B.

Although the figures schematically illustrate one alloying particle 16 per matrix opening, more than one alloying particle 16 may be in one matrix opening. A carbon material 20 such as carbon black can fill the voids between the electrically activated matrix 18 and the active material 14. The active material 14 can include graphite and alloying particles 16 of silicon. The alloying particles 16 can also be tin, germanium and any other material known to those skilled in the art that has a high capacity for lithium.

The electrodes 10, 100 have a current collector 22 and a separator 24, as illustrated in FIGS. 6-8. The electrically activated matrix 18 can be provided on the current collector 22 as shown in FIG. 6, with the functionalized polymer forming the electrically activated matrix 18 selected to provide expansion and contraction in a direction Z parallel to an electrode stacking direction. An end 26 of the electrically activated matrix 18 opposite the current collector 22 is spaced from the separator 24, the electrically activated matrix 18 and the alloyed particles 16 expanding in the stacking direction Z toward the separator 24. The electrically activated matrix 18 can be a drop in structure that is attached to the current collector 22 with conductive adhesive and filled with the active material 14.

As shown in FIG. 7, the electrodes 10, 100 can include a first buffer layer 28 of graphite between the current collector 22 and the active material layer 12. The first buffer layer 28 can alternatively be made from another material so long as the material is conductive and flexible, such as conducting polymers, metal rubber, and other carbon material. The first buffer layer 28 further protects the current collector 22 against damage and delamination from the active material 14 due to expansion of the alloying particles 16.

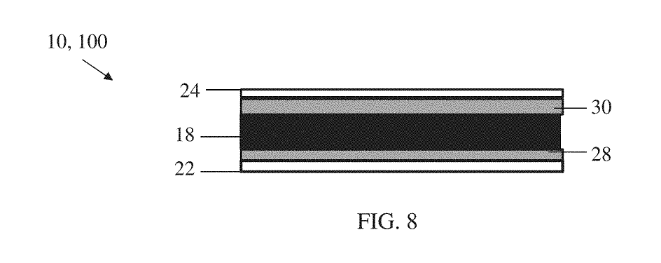

As shown in FIG. 8, the electrodes 10, 100 can further include a second buffer layer 30 between the active material layer 12 and the separator 24. The second buffer layer 30 further protects the separator 24 against damage from the active material 14 due to expansion of the alloying particles 16.

Also disclosed herein are lithium ion batteries including the electrodes described above as anodes.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A or B, X can include A alone, X can include B alone or X can include both A and B. In addition, the articles “a” and “an” as used in this application and the appended claims should generally be construed to mean “one or more” unless specified otherwise or clear from context to be directed to a singular form.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

Other embodiments or implementations may be within the scope of the following claims.

What is claimed is:

1. An electrode for a lithium ion battery, the electrode having an active material layer comprising:
an active material comprising alloying particles having high specific capacities; and
an electrically activated matrix formed from a functionalized polymer material, the active material being provided in the electrically activated matrix, wherein the electrically activated matrix is configured to undergo expansion and contraction during activation.

2. The electrode of claim 1, wherein, during discharge, the alloying particles are in an expanding state due to lithiation, and the electrically activated matrix is in an expandable state due to electrical activation, such that as the alloying particles expand against the electrically activated matrix, the electrically activated matrix also expands; and
during charging, the alloyed particles contract to an unexpanded state due to delithiation and the electrically activated matrix contracts with the alloying particles.

3. The electrode of claim 2, wherein the electrically activated matrix expands in only one directional plane, allowing the alloying particles to expand in the only one directional plane.

4. The electrode of claim 1, wherein voids between the electrically activated matrix and the alloying particles are filled with a carbon material.

5. The electrode claim 1, wherein the active material comprises graphite and alloying particles of silicon.

6. The electrode of claim 1, wherein the active material comprises graphite and alloying particles of one or both of tin and germanium.

7. The electrode of claim 1 further comprising a current collector and a separator, the electrically activated matrix provided on the current collector, the functionalized polymer forming the electrically activated matrix selected to provide expansion and contraction in a direction parallel to an electrode stacking direction.

8. The electrode of claim 7, wherein an end of the electrically activated matrix opposite the current collector is spaced from the separator, the electrically activated matrix and the alloyed particles expanding in the stacking direction toward the separator.

9. The electrode of claim 7, wherein the electrically activated matrix is attached to the current collector with conductive adhesive.

10. The electrode of claim 7, further comprising a first buffer layer of a flexible, conductive material between the current collector and the active material layer.

11. The electrode of claim 10, further comprising a second buffer layer between the active material layer and the separator.

12. The electrode of claim 1, wherein, during discharge, the alloying particles are in an expanding state due to lithiation and the electrically activated matrix is in a contracting state due to electrical activation, such that as the alloying particles attempt to expand against the electrically activated matrix, the electrically activated matrix exerts an opposite force on the alloying particles, forcing the alloying particles to expand away from the electrically activated matrix; and
during charging, the alloying particles contract to an unexpanded state due to delithiation.

13. The electrode of claim 12, further comprising a current collector adjacent the active material layer and a separator adjacent the active material layer opposite the current collector, the electrically activated matrix formed of walls perpendicular to the current collector, the walls contracting against the alloying particles in the expanding state, forcing expansion of the active material layer toward the separator.

14. A lithium ion battery having an anode comprising:
a current collector;
a separator;
an electrically activated matrix formed from a polymer material having a functional group capable of changing chain length upon electrical activation, the electrically activated matrix positioned between the current collector and the separator; and
an active material layer comprising alloying particles that undergo volume expansion of greater than 50% during discharge of the battery, the active material being deposited in the electrically activated matrix, wherein:
during discharge of the battery, the alloying particles are in an expanded state and the electrically activated matrix is in a contracted state due to electrical activation, such that a force on the alloying particles from the electrically activated matrix in the contracted state forces expansion of the alloying particles in one planar direction; and
during charging of the battery, the alloying particles are in an unexpanded state and the electrically activated matrix is in an uncontracted state.

15. The lithium ion battery of claim 7, wherein the active material comprises graphite and alloying particles of silicon.

16. The lithium ion battery of claim 7, wherein the electrically activated matrix is formed on the current collector and aligned to provide expansion of the alloying particles in a stacking direction.

17. The lithium ion battery of claim 1, wherein an end of the matrix opposite the current collector is spaced from the separator, the alloying particles expanding in the stacking direction toward the separator.

18. The lithium ion battery of claim 1, wherein the matrix is attached to the current collector with conductive adhesive.
